(19) United States
(12) Patent Application Publication
(10) Pub. No.: US 2010/0021643 A1
(43) Pub. Date: Jan. 28, 2010

(54) Method of Forming a Turbine Engine Component Having a Vapor Resistant Layer

(75) Inventors: Jay E. Lane, Mooresville, IN (US); Gary B. Merrill, Orlando, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS POWER GENERATION, INC., Orlando, FL (US)

(21) Appl. No.: 12/177,567

(22) Filed: Jul. 22, 2008

(51) Int. Cl. B05D 3/08

(52) U.S. Cl. 427/376.2

(57) ABSTRACT

A method of forming a turbine component that includes a ceramic matrix composite-ceramic insulation composite with a vapor resistant layer is disclosed. The method includes providing an inner tool and an outer tool, wherein the inner and outer tools define a mold for forming a turbine component. A vapor resistant layer can be applied to the inner tool, and a ceramic insulation layer can be applied over the vapor resistant layer in the mold. The vapor resistant layer and the ceramic insulation layer can be partially fired to form a bisque turbine component, and the outer tool can be removed. The inner tool can include a transitory material. A layer of ceramic matrix composite material can be applied to the outside of the bisque turbine component to form a component, and the component can be fired to form a turbine component.

### FIELD OF THE INVENTION

The present invention is directed generally to a method of forming a ceramic turbine component having a vapor resistant layer.

### BACKGROUND OF THE INVENTION

The firing temperatures produced in combustion turbine engines continue to be increased in order to improve the efficiency of the machines. Turbine engine components that include ceramic matrix composite (CMC) materials have been developed for applications where the firing temperatures may exceed the safe operating range for metal components. U.S. Pat. No. 6,197,424, describes a gas turbine component fabricated from CMC material and covered by a layer of a dimensionally stable, abradable, ceramic insulating material, commonly referred to as friable graded insulation (FGI).

Several processes have been developed for manufacturing turbine components from FGI/CMC composite materials. For example, U.S. Pat. No. 7,093,359 discloses a composite structure formed by a CMC-on-insulation process, and U.S. Pat. No. 7,351,364 discloses a method of manufacturing a hybrid FGI/CMC structure. These hybrid FGI/CMC components offer great potential for use in the high temperature environment of a gas turbine engine.

### SUMMARY OF THE INVENTION

The present invention is directed to a method of manufacturing ceramic turbine components that include a vapor resistant layer. The method of forming a turbine component having a vapor resistant layer can include providing an inner tool and an outer tool, wherein the inner and outer tools define a mold for forming a turbine component. A vapor resistant layer can be applied to the inner tool, and a ceramic insulation layer can be applied over the vapor resistant layer in the mold. The vapor resistant layer and the ceramic insulation layer can be partially fired to form a bisque turbine component. The outer tool can then be removed. The ceramic insulation layer can be a friable graded insulation.

The inner tool can include a transitory material. The transitory material can be removed in order to remove the inner tool. The transitory material and the inner tool can be removed after the bisque turbine component is formed.

The vapor resistant layer can have a composition selected from the group consisting of HfSiO₄; ZrSiO₄; Y₂Si₂O₇; Y₂O₃; ZrO₂; HfO₂; ZrO₂ stabilized by yttria, RE or both; HfO₂ stabilized by yttria, RE or both; ZrO₂/HfO₂ stabilized by yttria, RE or both; yttrium aluminum garnet; RE silicates of the form RE₂Si₂O₇; RE oxides of the form RE₂O₃; RE zirconates or hafnates of the form RE₄Zr₃O₁₂ or RE₄Hf₃O₁₂; and combinations thereof, wherein RE is one or more of Ce, Pr, Nd, Sm, Eu, Gd, Tb, Dy, Ho, Er, Tm, Yb, and Lu. The vapor resistant layer can be applied in the form of a viscous paste, a paint, a tape, a spray, or a combination thereof.

The vapor resistant layer can be applied to the inner tool using an intermediate outer tool, wherein the inner tool and the intermediate outer tool form a mold for casting the vapor resistant layer. The vapor resistant layer can be stabilized and the intermediate outer tool can be removed before applying the ceramic insulation layer. The vapor resistant layer can be stabilized by a process comprising heating, drying, curing, and combinations thereof. The vapor resistant layer can be stabilized, and diffusion between the vapor resistant layer and the ceramic insulation layer can occur before or during the partial firing step.

The method can also include applying a layer of ceramic matrix composite material to the outside of the bisque turbine component to form a component and firing the component. The ceramic matrix composite material can be compacted using a CMC compaction tool. The CMC compacting step can occur before the firing step. The ceramic insulation layer of the bisque turbine component can be machined before applying the ceramic matrix composite layer.

After the inner tool is removed, an inner machining tool comprising a second transitory material can be installed in the bisque turbine component. The ceramic insulation layer of the bisque turbine component can be machined after installing the inner machining tool and before applying the ceramic matrix composite layer. The transitory material and the second transitory material can be different materials. The second transitory material and the inner machining tool can be removed after machining the ceramic insulation layer of the bisque turbine component.

The component formed can be a turbine component selected from the group consisting of transitions, combustor liners, combustor ring segments, vane shrouds and blade platform covers.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a cylindrical turbine engine component formed using the method of the present invention.

FIG. 2 is a cross-sectional view of the cylindrical turbine engine component of FIG. 1 taken along section line 2-2.

FIG. 3 is a cross-sectional view of a mold formed by an inner tool and an outer tool.

FIG. 4 is a cross-sectional view of a vapor resistant layer formed using a mold between an inner tool and an intermediate outer tool.

FIG. 5 is a cross-sectional view of a vapor resistant layer applied to an inner tool that includes a transitory material.

FIG. 6 is a cross-sectional view of a vapor resistant layer and a ceramic insulating layer formed using a mold between an inner tool and an outer tool.

FIG. 7 is a cross-sectional view of a bisque turbine component of the present invention.

FIG. 8 is a cross-sectional view of a turbine component formed using a mold between an inner machining tool and a CMC compaction tool.

FIG. 9 is a front view of CMC fibers being applied to a bisque turbine component as part of the CMC application process.

### DETAILED DESCRIPTION OF THE INVENTION

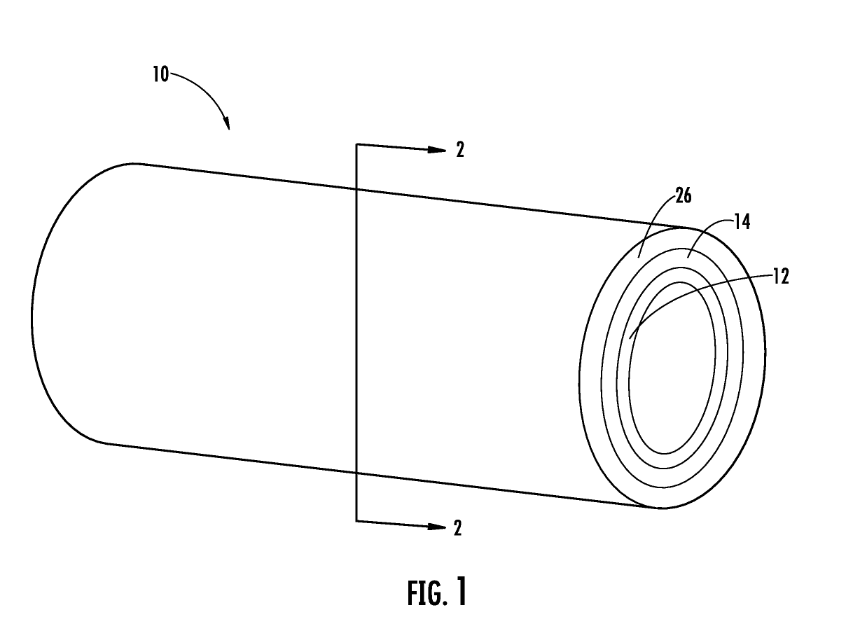

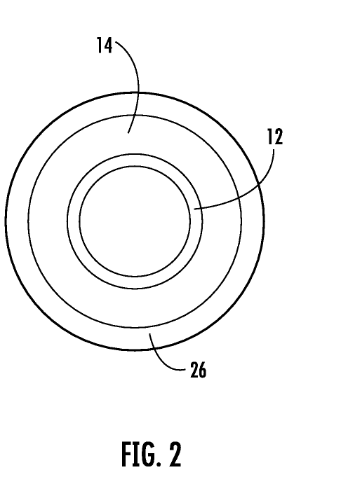

As shown in FIGS. 1 and 2, this invention is directed to an improved, lower cost hybrid FGI/CMC (friable graded insulation/ceramic matrix composite) manufacturing process that incorporates a vapor resistant layer 12 into the manufacturing process for forming a component 10. The process of manufacturing the component can incorporate near net FGI 14 casting to reduce machining and lower costs, provide a smoother hot face for improved component aerodynamics, reduce the number of tools and manufacturing operations, and provide a component 10 with in-situ manufactured water vapor resistance for natural gas, hydrogen or syngas fueled and oxyfuel turbines.

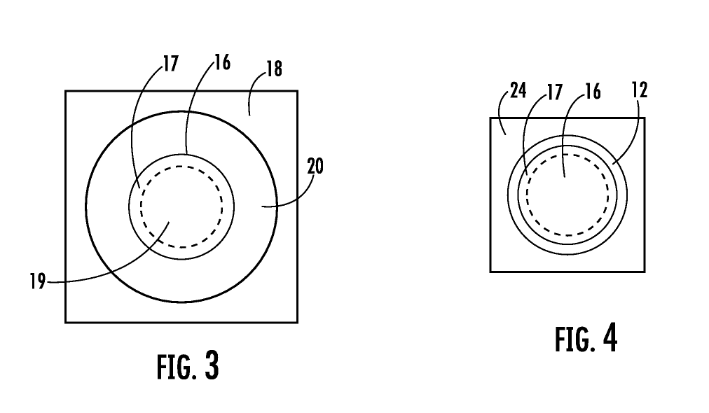

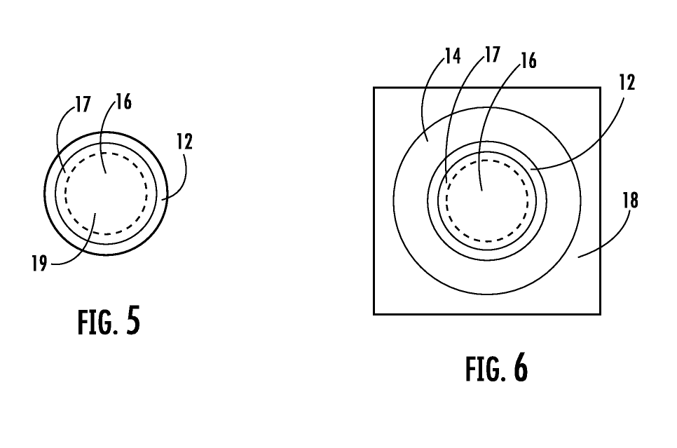

The invention includes a method of forming a turbine component 10 having a vapor resistant layer 12 that can include providing an inner tool 16 and an outer tool 18, wherein the inner 16 and outer tool 18 define a mold 20 for forming a turbine component, as shown in FIG. 3. A vapor resistant layer 12 can be applied to the inner tool 16 and a ceramic insulation layer 14 can be applied over the vapor resistant layer 12 in the mold 20. The vapor resistant layer 12 and the ceramic insulation layer 14 can be partially fired to form a bisque turbine component 22. The outer tool 18 can then be removed. The ceramic insulation layer 14 can be a friable graded insulation.

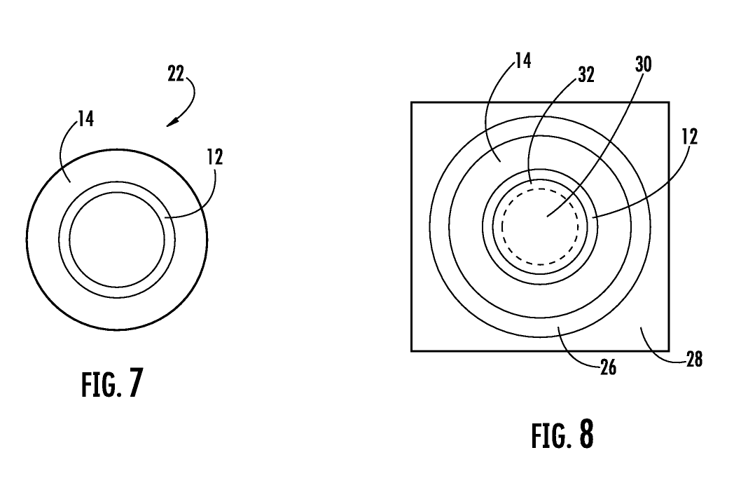

As shown in FIG. 3, the inner tool 16 can include a transitory material 17. The transitory material 17 can be removed in order to remove the inner tool 16 after the bisque component 22 is formed. As shown in FIG. 7, the transitory material 17 and the inner tool 16 can be removed after the bisque turbine component 22 is formed. As used herein, a “bisque turbine component” is a component that has been partially fired. For example, where the sintering temperature of the FGI layer 14 is approximately 1600 degrees Celsius, a bisque FGI layer 14 can be formed by partially firing the FGI layer 14 at about 1300 degrees Celsius or less, or about 1200 degrees Celsius or less, or about 1000 degrees Celsius or less.

As used herein, a “friable graded insulation” includes coarse-grain refractory materials useful as ceramic insulation, including insulations formed from a plurality of hollow oxide-based spheres of various dimensions, a refractory binder and at least one oxide filler powder, such as those described in U.S. Pat. No. 6,197,424 by Morrison et al., the entirety of which is incorporated herein by reference. As used herein, “transitory materials” 17 include any material that is thermally and dimensionally stable enough to support the vapor resistant layer 12, the ceramic insulating material 14, or both, through a first set of manufacturing steps, and that can then be removed in a manner that does not harm the vapor resistant layer 12, such as by melting, vaporizing, dissolving, leaching, crushing, abrasion, crushing, sanding, oxidizing, or other appropriate methods.

In one embodiment, the transitory material 17 may be styrene foam that can be partially transformed and removed by mechanical abrasion and light sanding, with complete removal being accomplished by heating. Because the inner mold 16 contains a transitory material portion 17, it is possible to form the mold 20 to have a large, complex shape, such as would be needed for a gas turbine transition duct, while still being able to remove the inner mold 16 after the vapor resistant layer 12 has solidified around the inner mold 12. As shown in FIG. 3, the inner mold 12 can consist of a hard, reusable permanent tool 19 with an outer layer of transitory material 17 of sufficient thickness to allow removal of the permanent tool 19 after the elimination of the fugitive material portion 17. The reusable tool 19 may be formed of multiple sections to facilitate removal from complex shapes.

The vapor resistant layer 12 can be formed from a composition including, but not limited to, HfSiO₄; ZrSiO₄; Y₂Si₂O₇; Y₂O₃; ZrO₂; HfO₂; ZrO₂ stabilized by yttria, HfO₂ stabilized by yttria, ZrO₂/HfO₂ stabilized by yttria, yttrium aluminum garnet; Rare Earth (RE) silicates of the form RE₂Si₂O₇; RE oxides of the form RE₂O₃; RE zirconates or hafnates of the form RE₄Zr₃O₁₂ or RE₄Hf₃O₁₂; and combinations thereof, wherein RE is one or more of Ce, Pr, Nd, Sm, Eu, Gd, Tb, Dy, Ho, Er, Tm, Yb, and Lu. The vapor resistant layer 12 can be applied in the form of a viscous paste, a paint, a spray, a tape, a combination thereof, or other appropriate form.

As shown in FIG. 4, the vapor resistant layer 12 can be applied to the inner tool 16 using an intermediate outer tool 24, wherein the inner tool 16 and the intermediate outer tool 24 form a mold for casting the vapor resistant layer 12. As shown in FIG. 5, the vapor resistant layer 12 can be stabilized, and the intermediate outer tool 24 can be removed before applying the ceramic insulation layer 14.

A slurry coating of a composition that is more vapor resistant than the ceramic insulating material 14 can be applied to an inner tool 16. The inner tool 16 can define a net shape or near net shape of the exposed surface of the final turbine component 10. The vapor resistant layer 12 can then be dried, partially fired, or both, so that it may accept the ceramic insulating material 14 during a subsequent partial firing process.

The vapor resistant layer 12 can be applied or cast onto the inner tool 16. For example, the vapor resistant layer 12 can be applied by a number of different processes including slurry coating the inner tool 16 surface, custom casting a layer using an intermediate outer tool 24, and applying a pre-prepared tape layer that can be applied to the inner tool 16, which can serve as a mandrel. In some embodiments, the inner tool 16 can include a transitory material 17 that can be removed by various methods including oxidation via combustion.

The vapor resistant layer 12 can be stabilized by a process comprising heating, drying, curing, and combinations thereof. The vapor resistant layer 12 can be partially stabilized, and diffusion between the vapor resistant layer 12 and the ceramic insulation layer 14 can occur before or during the partial firing step. For example, the vapor resistant layer 12 can be dried or partially cured before application of the ceramic insulating material 14. This enables improved diffusion and bonding between the vapor resistant layer 12 and the ceramic insulating material 14 during formation of the bisque turbine component 22. Using the techniques provided herein, it is possible for the vapor resistant layer 12 to from a hermetic or near hermetic seal over the ceramic insulating material 14.

The method can also include applying a layer of ceramic matrix composite 26 material to the outside of the bisque turbine component 22 to form a component 10 and firing the component 10. The ceramic matrix composite 26 material can be compacted using a CMC compaction tool 28, as shown in FIG. 8. The CMC compacting step can occur before the firing or sintering step. The ceramic insulation layer 14 of the bisque turbine component 22 can be machined before applying the ceramic matrix composite layer 26.

The partial firing of the bisque component 22 can serve at least three purposes. First, the partial firing can help to stabilize the bisque component during subsequent processing steps. Second, the bisque structure 22 has not been fully densified, which can allow for improved diffusion, both thermal and viscous, of the CMC material 26 into the ceramic insulating layer 14. Finally, both the CMC 26 and bisque component 22 are densified during the final firing step, which can help minimize or prevent undue interfacial stresses from forming between the CMC 26 and the ceramic insulating material 14. As used herein, the unmodified term “stabilized” includes fully stabilized, partially stabilized (i.e. fully or partially sintered/fired), or both.

After the inner tool 16 has been removed, an inner machining tool 30 comprising a second transitory material 32 can be installed in the bisque turbine component 22, as shown in FIG. 8. The ceramic insulation layer 14 of the bisque turbine component 22 can be machined after installing the inner machining tool 30 and before applying the ceramic matrix composite layer 26. The transitory material 17 and the second transitory material 32 can be different materials. The second transitory material 32 and the inner machining tool 30 can be removed after machining the ceramic insulation layer 14 of the bisque turbine component 22.

The component 10 that is formed can be a turbine component including, but not limited to, a transition, combustor line, combustor ring segment, vane shroud and blade platform cover. The present method is not limited to these components and may be adapted to form other turbine components as well.

After the bisque turbine component 22 has been formed, CMC 26 can be applied to form a turbine composite 10 comprising a hybrid VRL/FGI/CMC system. For example, the CMC 26 can be applied to the bisque turbine component 22 using the techniques disclosed in U.S. Pat. Nos. 7,093,359 and 7,351,364, the entireties of which are incorporated herein by reference.

Once the bisque turbine component 22 is formed, an inner machining tool 30 can be used to help support the bisque turbine component 22 during the subsequent machining, firing, or both. The inner machining tool 30 and the non-transitory portions of the tool disclosed herein can be manufactured of a refractory material. The inner machining tool 30 can be manufactured of a material with a coefficient of thermal expansion similar to that of the turbine component system 10. This can help prevent excessive stresses from being generated between layers of the turbine component 10.

Following removal of the outer tool 18, the thickness of the layer of ceramic insulating material 14 can be reduced using a mechanical process such as by machining the insulating material 14 in its partially or fully stabilized state with the inner tool 16 in place. The outer surface of the insulating material 14 can be prepared for receiving a ceramic matrix composite layer 26 while the inner tool 16 remains in place to provide support for the VRL 12 and the ceramic insulating material 14 during the CMC application process. The CMC application process can include the application of any CMC precursor form including, but not limited to, fiber tows, fabric strips or fabric sheets that can be applied by either hand or machine processes to conform to the bisque turbine component 22 before final firing step. The CMC material 26 can be any known oxide or non-oxide composite. It may be desired to at least partially cure the VRL 12 and ceramic insulating material 14 before removing the inner tool 16.

If the transitory material is transformed by heat, the curing temperature during processes before removal of the inner tool 16 can be less than a transformation temperature of the transitory material portion 17 of inner tool 16. Thus, the mechanical support provided by the inner tool 16 is maintained. Consecutive layers of the CMC 14 material may be applied to build rigidity and strength into the turbine component 10.

The bisque turbine component 22 can provide adequate mechanical support for the machining step, the application of the CMC 26 material, or both, thereby allowing the inner tool 12 to be removed. Alternatively, the inner tool 12 can remain in place through the entire processing of the turbine component 10. At an appropriate point in the manufacturing process, the transitory material portion 17 of inner tool 16 can be transformed, the inner tool 12 removed, and the turbine component 10 processed to its final configuration.

If the ceramic insulating material 14 is not machinable in its green state, or if the transitory material 17 is not stable at a desired firing temperature, the transitory material 17 and inner mold 12 can be removed before the firing step, and an inner machining mold 30 may be installed before the firing step or as a support before a subsequent mechanical processing step, such as machining or applying a layer of CMC material 26. The transitory material portions 17, 32 of the first inner mold 16 and the inner machining mold 30, respectively, do not necessarily have to be the same material. For example, the transitory material 32 used in the inner machining tool 30 can be specially selected to be compatible with chemicals used in a machining fluid or at temperatures required for an intermediate or final sintering step.

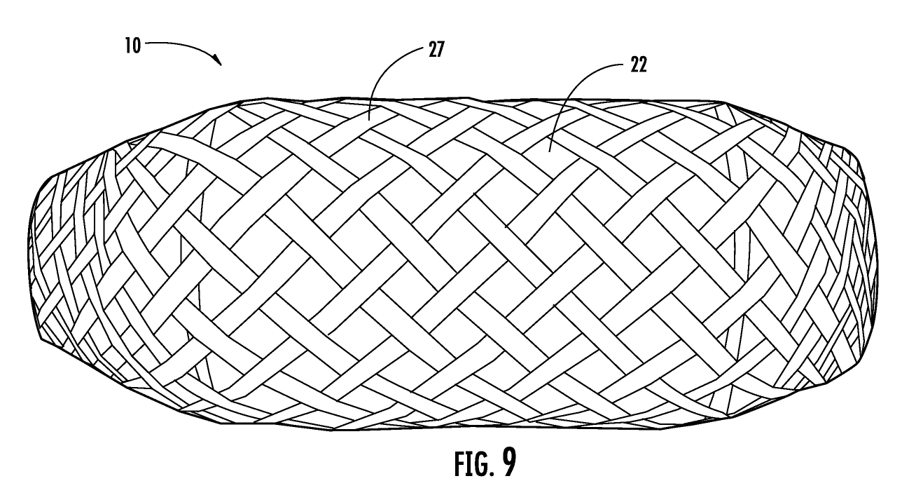

In instances where the CMC layer 26 is being applied to a cylindrical bisque turbine component 22, the outside surface of the bisque turbine component 22 can serve as a mold for the subsequent deposition of a CMC layer. For example, the CMC layer 26 can be formed by winding of a plurality of layers of ceramic fibers 27 around the bisque turbine component 22. A refractory bonding agent may be applied to the exterior of the bisque turbine component 22 before the addition of the ceramic fibers 27. FIG. 9 illustrates the composite component at a stage when only a portion of the layers of ceramic fibers 27 have been wound around the bisque turbine component 22 and before the CMC layer 26 is subjected to autoclave curing. The ceramic fibers 27 can be wound dry and followed by a matrix infiltration step, deposited as part of a wet lay-up, or deposited as a dry fabric (including greater than 2D fabrics) followed by matrix infiltration. Any of these methods can be used with an applied pressure, such as that created by a CMC compaction tool 28, to consolidate the CMC layer 26 with processes and equipment known in the art. Fiber and matrix materials used for the CMC layer 26 may be oxide or non-oxide ceramic materials, including, but not limited to, mullite, alumina, aluminosilicate, silicon carbide, or silicon nitride. The CMC layer 26 can fully conform to the dimensions of the outside of the bisque turbine component 22 and the matrix material can at least partially infiltrate into pores of the ceramic insulating layer 14 of the bisque turbine component 22. FIG. 2 illustrates a cross-sectional view of a portion of the finished turbine component 10 showing the seamless interfaces between the VRL 12 and ceramic insulating material 14 and between the ceramic insulating material 14 and the CMC layer 26.

The tools disclosed herein can be made of a porous material. The use of tools with different pore sizes accelerated or inhibit heating, cooling and moisture removal during the process disclosed herein. Thus, the porosity of the tools is a variable that can be used to manipulate the properties of the turbine components 10 formed using the methods disclosed herein.

The foregoing is provided for purposes of illustrating, explaining, and describing embodiments of this invention. Modifications and adaptations to these embodiments will be apparent to those skilled in the art and may be made without departing from the scope or spirit of this invention.

1. A method of forming a turbine component having a vapor resistant layer, comprising:
providing an inner tool and an outer tool, wherein the inner and outer tools define a mold for forming a turbine component;
applying a vapor resistant layer to the inner tool;
applying a ceramic insulation layer over the vapor resistant layer in the mold;
partially firing the vapor resistant layer and the ceramic insulation layer to form a bisque turbine component; and
removing the outer tool.

2. The method of claim 1, wherein providing the inner tool comprises providing the inner tool comprising a transitory material.

3. The method of claim 2, further comprising removing the transitory material and the inner tool.

4. The method of claim 2, further comprising removing the transitory material and the inner tool after forming the bisque turbine component.

5. The method of claim 1, wherein applying the vapor resistant layer comprises applying the vapor resistant layer comprising a composition selected from the group consisting of HfSiO₄; ZrSiO₄; Y₂Si₂O₇; Y₂O₃; ZrO₂; HfO₂; ZrO₂ stabilized by yttria, HfO₂ stabilized by yttria, ZrO₂/HfO₂ stabilized by yttria, yttrium aluminum garnet; Rare Earth (RE) silicates of the form RE₂Si₂O₇; RE oxides of the form RE₂O₃; RE zirconates or hafnates of the form RE₄Zr₃O₁₂ or RE₄Hf₃O₁₂; and combinations thereof, wherein RE is one or more of Ce, Pr, Nd, Sm, Eu, Gd, Tb, Dy, Ho, Er, Tm, Yb, and Lu.

6. The method of claim 1, further comprising,
applying a layer of ceramic matrix composite material to the outside of the bisque turbine component to form a component; and
firing the component.

7. The method of claim 6, further comprising machining the ceramic insulation layer of the bisque turbine component before applying the ceramic matrix composite layer.

8. The method of claim 6, wherein providing an inner tool comprises providing the inner tool comprising a transitory material, and the method further comprises removing the transitory material and the inner tool.

9. The method of claim 8, further comprising installing a inner machining tool in the bisque turbine component after the inner tool is removed, wherein the inner machining tool comprises a second transitory material.

10. The method of claim 9, further comprising machining the ceramic insulation layer of the bisque turbine component after installing the inner machining tool and before applying the ceramic matrix composite layer.

11. The method of claim 10, wherein the transitory material and the second transitory material are different.

12. The method of claim 10, further comprising removing the second transitory material and the inner machining tool after machining the ceramic insulation layer of the bisque turbine component.

13. The method of claim 6, further comprising compacting the ceramic matrix composite material using a CMC compaction tool.

14. The method of claim 6, wherein the component is a turbine component selected from the group consisting of transitions, combustor liners, combustor ring segments, vane shrouds and blade platform covers.

15. The method of claim 1, wherein applying the vapor resistant layer comprises applying the vapor resistant layer in the form of a viscous paste, a paint, a tape, a spray, or a combination thereof.

16. The method of claim 1, wherein applying the vapor resistant layer comprises applying the vapor resistant layer to the inner tool using an intermediate outer tool, wherein the inner tool and the intermediate outer tool form a mold for casting the vapor resistant layer.

17. The method of claim 16, further comprising,
stabilizing the vapor resistant layer; and
removing the intermediate outer tool before applying the ceramic insulation layer.

18. The method of claim 1, further comprising stabilizing the vapor resistant layer, wherein the vapor resistant layer is stabilized by a process comprising heating, drying, curing, and combinations thereof.

19. The method of claim 18, wherein the vapor resistant layer is partially stabilized and diffusion between the vapor resistant layer and the ceramic insulation layer occurs before or during the partial firing step.

20. The method of claim 1, wherein applying the ceramic insulation layer comprises applying a friable graded insulation.
